(19) United States
(12) Patent Application Publication
(10) Pub. No.: US 2016/0000647 A1
(43) Pub. Date: Jan. 7, 2016

(54) Battery-Powered Leg Vibration Unit

(71) Applicant: Mark J. Eberhardt, Kenosha, WI (US)

(72) Inventor: Mark J. Eberhardt, Kenosha, WI (US)

(21) Appl. No.: 14/793,409

(22) Filed: Jul. 7, 2015

Related U.S. Application Data
(60) Provisional application No. 62/021,405, filed on Jul. 7, 2014.

(51) Int. Cl. A61H 23/02

(52) U.S. Cl. CPC A61H 23/0263

(57) ABSTRACT

A battery-powered leg vibration apparatus includes a housing holding a massage unit powered by sealed batteries. A timer and foot presence sensor may manage power to the massage unit motor to conserve power allowing practical use of battery systems in public spaces and hotel rooms.

### CROSS REFERENCE TO RELATED APPLICATION

This application claims the benefit of U.S. Provisional Application No. 62/021,405 filed Jul. 7, 2014, and hereby incorporated by reference.

### FIELD OF THE INVENTION

The present invention relates to whole body vibration equipment and in particular to a leg vibration unit operating on battery power.

### BACKGROUND OF THE INVENTION

Air travelers, subject to long periods of time sitting in a confined space, may be susceptible to health risks caused by reduced blood circulation. Recently, whole body vibration has been recognized as a method of improving blood circulation through an eccentric muscle reaction promoted by the vibration. Ideally, leg vibration units would be positioned in airports near existing seating allowing travelers to receive a massage between or before and after flights. Unfortunately, the logistics of providing electricity to multiple distributed leg vibration units in a seating area is largely impractical, requiring the costly addition of multiple floor-mounted power outlets (to avoid the trip hazards of cords in the vicinity of the seating area).

### SUMMARY OF THE INVENTION

The present inventor has realized that the relatively low treatment time of the typical leg vibration unit permits the practical construction of a battery-powered leg vibration unit despite the relatively high current draw of the leg vibration motor. In particular, using a portable charging system that allows a stationary massage unit (accommodating larger and relatively heavy batteries), using an efficient DC massage motor, and providing automatic shutoff provisions that conserve power, all combined to provide 2 to 3 days of typical usage before recharging is required. This recharging rate can be performed economically on a periodic basis much the same way that occurs with vending machine restocking.

Specifically the present invention provides a leg vibration unit having a housing providing a base supportable on a floor and an opening in a front side of the housing. The housing has a electric vibration unit fixed within the housing and having a footplate for receiving a user's feet, the footplate being angled and the opening positioned so that a user may place his or her feet on the footplate from an adjacent seat displaced horizontally from the housing when the base is positioned on the floor proximate to the seat. At least one battery is positioned within the housing and sized to provide power necessary to operate the electric vibration unit for no less than five minutes and a control unit controls the application of power from the batteries to the electric vibration unit according to a predetermined time period.

It is thus a feature of at least one embodiment of the invention to provide easily installed leg vibration units that may be placed, for example, in an airport at existing seating without the need for electrical outlet proximity or the hazards of power cords extending over the floor.

The housing may further include a charge indicator exposed on an outer surface of the housing indicating a charge state of the batteries.

It is thus a feature of at least one embodiment of the invention to permit massage units needing recharging to be quickly identified and charged in a commercial environment where multiple massage units are placed in a seating area.

The housing may further include a charging port exposed on an outer surface of the housing for receiving electrical power from an external charging device and communicating that power to charge at least one battery.

It is thus a feature of at least one embodiment of the invention to provide simple access to the batteries for charging without the need for battery removal or exposure.

The housing may further include a foot presence sensor communicating with the control unit to remove power from at least one battery to the electric massage unit when the foot presence sensor indicates that the user's feet are not present on the footplate of the electric vibration unit.

It is thus a feature of at least one embodiment of the invention to maximize the conservation of electrical power by deactivating the massage unit when the full amount of massage time is not required by a user.

The housing may further include a device charging port exposed on an outer surface of the housing for providing electrical power from at least one battery to an external device for charging the batteries of the external device.

It is thus a feature of at least one embodiment of the invention to provide far greater access to charging outlets in an airport or the like by providing a battery-powered charging station making use of the existing massage unit batteries.

The device charging port conforms to the USB standard.

It is thus a feature of at least one embodiment of the invention to make use of the currently most common standard for device charging ports.

The leg vibration unit may employ a DC electric motor.

It is thus a feature of at least one embodiment of the invention to eliminate electrical loss of an inverter circuit necessary when an AC motor is employed.

The control unit further includes a radio transmitter for transmitting an indication of the state of the batteries together with an identification of the leg vibration unit.

It is thus a feature of at least one embodiment of the invention to provide a practical method of deploying battery-powered massage units to a large facility while practically managing costs.

The leg vibration unit may further include a payment receipt unit exposed on an outer surface of the housing for receiving payment for massage time, and the control unit controls the application of power from the batteries to the electric vibration unit according to whether payment is received.

It is thus a feature of at least one embodiment of the invention to provide sustainable, increased availability of leg vibration equipment shown to have significant health benefits for travelers subject to prolonged inactivity in planes and the like.

The control unit may deactivate the payment receipt unit to prevent receipt of payment when at least one battery has a charge below a predetermined amount still sufficient to operate the control unit and the payment receipt unit.

It is thus a feature of at least one embodiment of the invention to mitigate customer dissatisfaction that may be possible when battery-powered massage units are subject to unexpected demand.

The housing further includes a cover at least partially positioned above the footplate.

It is thus a feature of at least one embodiment of the invention to permit the use of such massage units in public spaces while discouraging the placement of articles such as luggage on the massage plate.

The cover may include a padded upper surface.

It is thus a feature of at least one embodiment of the invention to provide potential additional seating capacity.

The cover may have an elevation of 17 to 22 inches above the floor when the base is on the floor and the cover is positioned to allow support of the user's feet when the base is positioned proximate to the seat of the user.

It is thus a feature of at least one embodiment of the invention to permit the unit to also be used by individuals to elevate their legs while sitting in a nearby chair.

Other features and advantages of the invention will become apparent to those skilled in the art upon review of the following detailed description, claims and drawings in which like numerals are used to designate like features.

### BRIEF DESCRIPTION OF THE DRAWINGS

FIG. 1 is a perspective view of the leg vibration unit of the present invention showing an opening through which a user's feet may be inserted to contact a vibrating platform of a massage unit;

FIG. 2 is a top plan cross-section of the leg vibration unit of FIG. 1 showing positioning of the leg vibration unit between baffle walls for sound reduction and showing the location of a manual timer unit;

FIG. 3 is a fragmentary detail of a lower corner of FIG. 2 showing an alternative embodiment having a credit card reader and a timing unit;

FIG. 4 is a schematic diagram of the components of the leg vibration unit shown in FIG. 2;

FIG. 5 is a fragmentary detail of a lower portion of FIG. 1 showing an alternative embodiment having a foot presence sensor;

FIG. 6 is a perspective view of the leg vibration unit of the present invention showing an alternative embodiment having a USB socket;

FIG. 7 is a top plan cross-section of the leg vibration unit of FIG. 6; and

FIG. 8 is to schematic diagram of the components of the leg vibration unit shown in FIG. 7.

Before the embodiments of the invention are explained in detail, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF TILE PREFERRED EMBODIMENTS

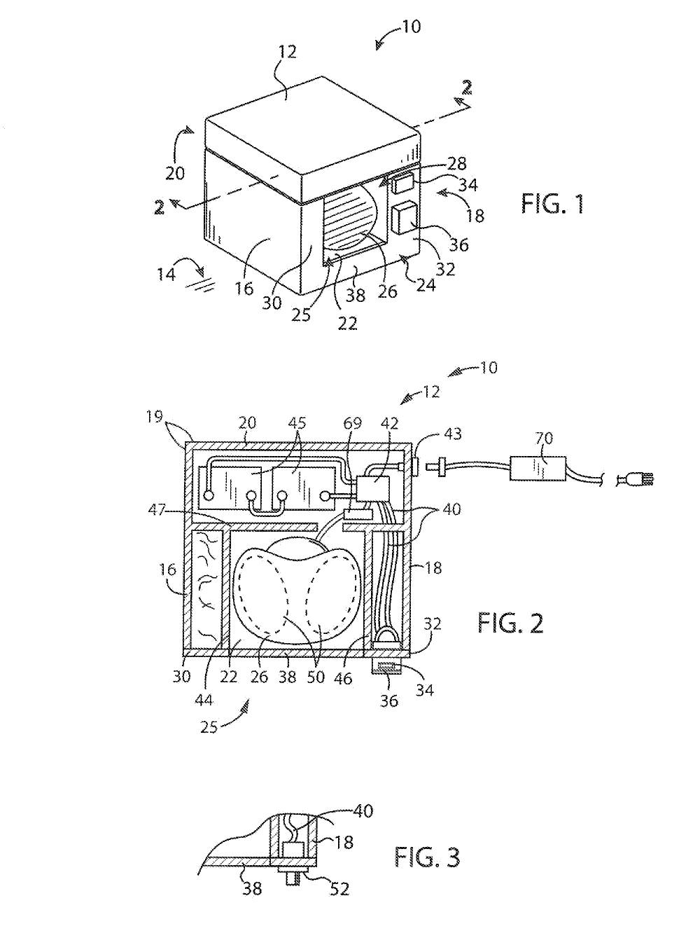

Referring now to FIGS. 1 and 3, a massage unit 10 of the present invention may, in one embodiment, provide a generally rectangular horizontal upper cushion 12, for example, being a substantially square rigid panel 15, such as plywood, topped with a polyurethane foam 17, the latter upholstered to the panel 15 with an upholstery material 19. The upholstery material may be a flame-retardant leather-like material (e.g., vinyl coated fabric) or fire resistant fabric. The massage unit 10 may provide for a height of 17 to 21 inches in one embodiment with a length from 24 to 26 inches and a width of about 20 inches. An example top cushion may be approximately 20 inches by 20 inches and three inches high.

A base 22 may be supported away from the floor by bun legs 21 positioned at the four corners of the base 22.

Referring to FIGS. 1 and 2, the top of the upper cushion 12 may be supported approximately 20 inches above the floor 14 by upstanding left and right sidewalls 16 and 18 and rear wall 20 each attached at their upper edges to a lower edge of the upper cushion 12 and at their lower edges to the base 22.

A front face 24 of the massage unit 10 provides an opening 25 to expose therethrough a footplate 26 of a massage unit 28 positioned beneath the upper cushion 12 in the cavity defined by the upper cushion 12, the base 22, the left and right sidewalls 16 and 18 and the rear wall 20. The massage unit 28 may, for example, include an electric motor having a cam or crank and arm acting on the footplate 26 for vibrating the same, or may provide an eccentric weight attached to and vibrating a spring-mounted footplate 26. In one embodiment the footplate 26 provides a surface of about one square foot and a width of about 12 inches and a height of about 12 inches bifurcated into two areas roughly corresponding to the shape of two feet. The footplate 26 may be spaced approximately 1 inch above the base 22 and sloping backward at about 45 degrees into the interior of the massage unit 10 as one moves up the footplate 26. The massage unit 28 may provide for whole body type vibrations having a fundamental frequency of approximately 1840 hertz. The body of the massage unit 28 may be bolted to the base 22 to prevent movement along the base plate and may be serviced by removal of the base 22 from the remainder of the massage unit 10.

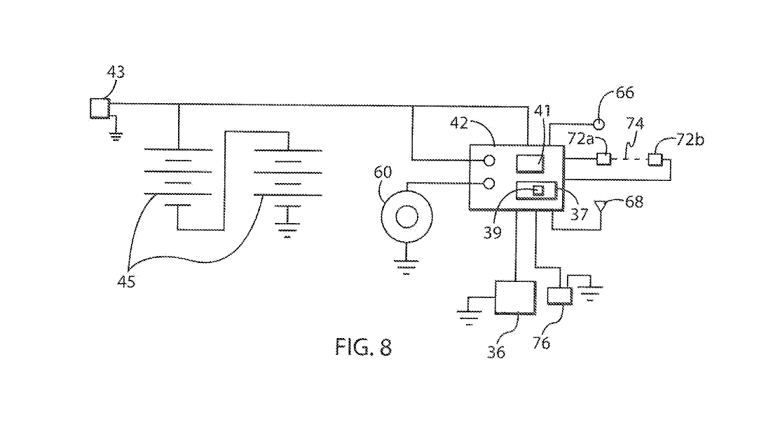

Referring now to FIGS. 5 and 8, in another embodiment, foot presence sensors 72 may be attached to the left and right sidewalls 44 and 46 near a bottom of the opening 25 above the retention ledge 38. More specifically, an LED 72a may project a light beam 74 generally horizontally across the opening 25 in a position that would necessarily be interrupted by the user's leg or foot when the user's feet are placed on the surface 50 of the footplate 26 of the massage unit 28. This light beam 74 is received by a photodetector 72b which by detecting the presence or absence of the light beam received at the photodetector 72b can detect the use of the leg vibration unit 28. The LED 72a and photodetector 72b may be recessed within respective walls 44 and 46 exposed through openings in those walls 44 and 46 so as to be protected from contact by the user's foot.

As shown in FIG. 8, the LED 72a may be controlled by the control unit 42, for example, to modulate the LED, and the signal from the photodetector 72b may be received by the control unit 42 which may demodulate the signal from the photodetector 72b (for example, by a high pass filtering) so as to detect only the beam 74 and not ambient lighting. The control unit 42 may operate to turn off the leg vibration unit 28 when the light beam 74 is not interrupted so as to conserve power, for example, when a customer leaves the massage unit before completion of the massage time. Other types of foot presence sensors 72 are also contemplated by the present invention including, for example, thermal sensing using passive infrared receivers (PIR) and electric field proximity sensors.

The control unit may generally be a printed circuit board including a microcontroller for executing a stored program and memory for holding a stored program executed by the microcontroller together with voltage regulators, radio transmitters, and other features as will be described below.

The opening 25 maybe flanked by left and right partial front walls 30 and 32 extending between the base 22 and the upper cushion 12 and attached along their outer vertical edges to corresponding edges of the left and right sidewalls 16 and 18. The left and right sidewalls 16 and 18, rear wall 20, base 22 and left and right partial front walls 30 and 32 may be panels of plywood or particle board similar to that of panel 15. The left and right sidewalls 16 and 18, rear wall 20, and left and right partial front walls 30 and 32 may also be upholstered with the upholstery material 19.

A lower edge of the left and right partial front walls 30 and 32 may be bridged by a retention ledge 38, for example, a metal strip providing a finished appearance to the opening and a lip retaining the massage unit 28.

The right side wall 18 may expose on its front face a display of a timer 34 indicating elapsed time and a wireless credit card reader 36. Wiring 40 may connect the tuner 34 and wireless credit card reader 36 to a control unit 42 receiving power from a charging socket 43 or internal sealed batteries 45. The tinier 34 and wireless credit card reader 36 may control the application of power to the massage unit 28 according to whether a credit card payment has been properly authorized and time remains of a predetermined purchased time increment on the timer 34. Generally upon receiving a valid credit card number transmitted from the wireless credit card reader 36, a predetermined time will be placed in the timer 34 and the massage unit 28 will operate until that predetermined time has elapsed. The wireless credit card reader 36 may be, for example, an ePort cashless payment system from USA Technologies Inc. of Malvern, Pa., USA, providing wireless credit card authorization and charging.

The wireless credit card reader 36 will be disabled if the batteries 45 do not have sufficient charge to provide a massage as determined by the control unit 42 even when the batteries have sufficient power to power the wireless credit card reader 36. In this way, customers are not charged if a massage cannot be properly delivered. Generally the control unit 42 may monitor the voltage on the batteries 45 and prevent the receipt of credit cards at below a predetermined voltage that is still adequate for powering of the control unit 42 and even providing limited operation of the massage unit 28.

The wiring 40, control unit 42, and internal sealed batteries 45 may be contained behind false left and right sidewalls 44 and 46 being generally parallel to left and right sidewalls 16 and 18 but displaced inwardly proximate to the left and right sides of the footplate 26 of the leg vibration unit 28 and mid wall 47 (shown in FIG. 2). The space between the false left and right sidewalls 44 and 46 and the left and right sidewalls 16 and 18 may also be filled with sound absorbing material (not shown for clarity). The stationary nature of the massage unit 10 makes it practical to provide sealed batteries of substantial capacity and weight needed to provide electrical power to a motor, the weight serving to better anchor the massage unit and stabilize it against vibration-induced movement

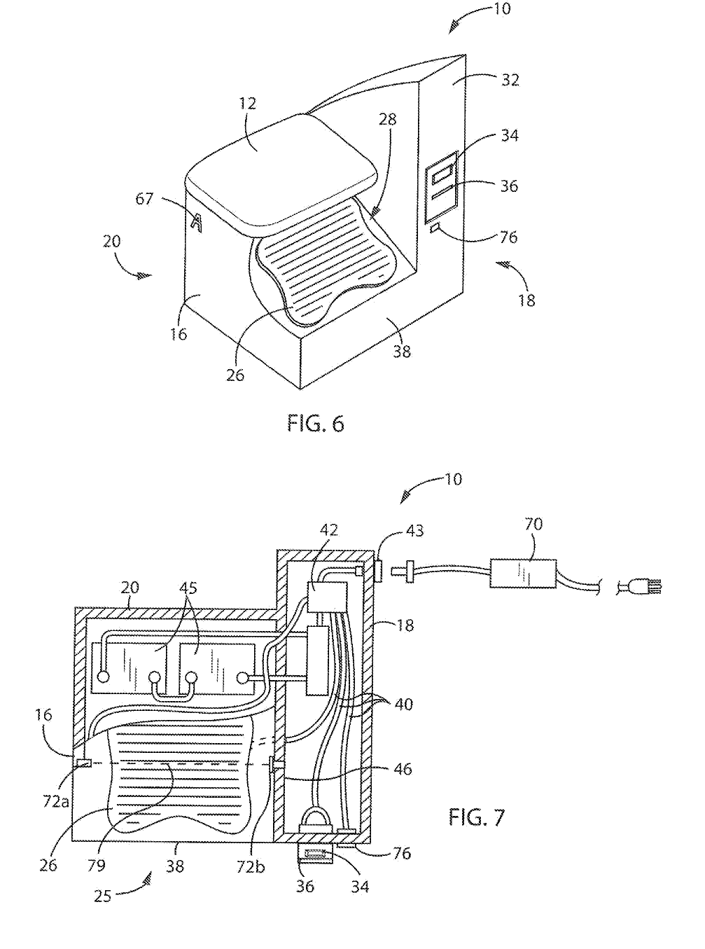

In an alternative embodiment, as shown in FIGS. 6 and 7, the right partial front wall 32 may also expose on its front lace a USB port 76 for use in charging a user's electronic device. Wiring 40 may connect the USB port 76 to the control unit 42 receiving power from the charging socket 43 or the internal sealed batteries 45. In this capacity, the control unit 42 may include voltage regulators, for example, a switching voltage regulator, for down convening the power of the batteries 45 to the appropriate level (five volts) for charging most handheld devices such as cell phones and the like. Application of power to the USB port 76 may also occur only when a credit card payment has been properly authorized and time remains of a predetermined purchased time increment on the timer 34. Power may be provided to the USB port 76 in these conditions even if the foot presence sensor 72 does not indicate the presence of the user's feet, thus allowing the USB charger to be used without a leg vibration. Generally the USB port 76 will conform to the power output standards and connector dimensions of the Universal Serial Bus 3.0 Standard promulgated by the USB Implementers Forum, Inc., hereby incorporated by reference. Alternatively or in addition, the USB port 76 may provide a USB cable on a retractable reel having a connector conforming to standard cell phone charging connectors (e.g., a mini USB connector) to accommodate users who do not have charging cables.

Referring to FIG. 2, the vibrating footplate 26 may provide for a surface 50 suitable for supporting a person's left and right feet thereupon through the opening 25. The upper surface of the base 22 may be carpeted over a carpet pad to further reduce vibration transmitted from the massage unit 28 or may have a thin layer of upholstery fabric.

The right side wall 18 may expose on its front face a display of a timer 34 indicating elapsed time and a wireless credit card reader 36. Wiring 40 may connect the timer 34 and wireless credit card reader 36 to a control unit 42 receiving power from a charging socket 43 or internal sealed batteries 45. The timer 34 and wireless credit card reader 36 will control the application of power to the massage unit 28 according to whether a credit card payment has been properly authorized and time remains of a predetermined purchased time increment on the timer 34.

Referring now to FIG. 3, in an alternative embodiment, the timer 34 and wireless credit card reader 36 may be replaced with a manual timer 52 for home use where use payment is not required.

Referring now to FIG. 8, each of the internal sealed batteries 45 may be a 12 volt, 35 amp-hour sealed lead acid battery. The batteries 45 may be wired in series to provide 24 volts to a motor 60 driving the massage unit 28. Preferably the motor 60 is a DC motor drawing one ampere or less. The DC motor may produce oscillations in the footplate 26 having a frequency between 30 and 60 hertz with the G force of substantially 1.6 g. This low intensity high-frequency is believed to provide the principal benefits of whole body vibration therapy.

This power is provided through the control unit 42 which may include an internal relay activated by a timer implemented through software of a program 39 held in memory 37 and executed on a processor 41. The program 39 executes so that power is provided only during a timed interval, after receiving a signal from the card reader 36 indicating payment (optionally confirmed through remote communication with a bank via wireless communication antenna 68 and an internal transceiver).

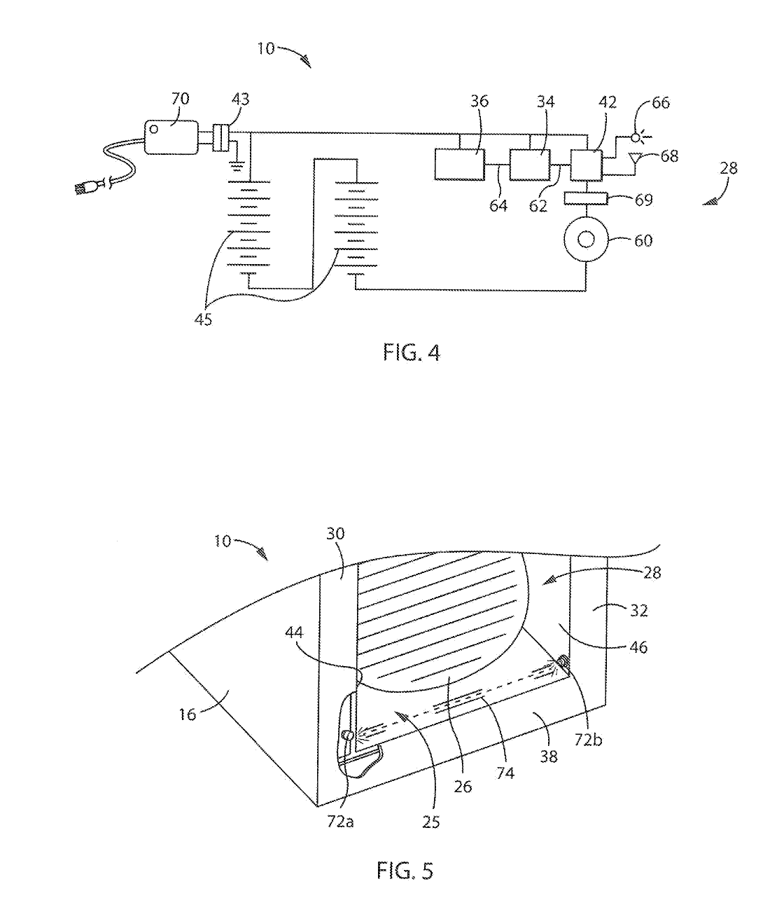

In an alternative embodiment shown in FIG. 4, the card reader 36 may activate a separate timer 34 which may also have a dial accessible to the user such as provided by manual timer 54 shown in FIG. 3. The timer output 62 signals the controller 42 to provide power to the motor 60 through an inverter 69 converting the DC power of the sealed batteries 45 to AC power for the motor 60 which in this case may be an AC motor. The inverter 69 is active only during use of the motor 60 so as to conserve electrical power at other times.

In both cases, power from the control unit 42 may also power USB port 76 and/or foot presence sensors 72. Timer 34 (or the software timer) may receive a start signal 64 from the card reader 36. Timer 34 may also receive a pause signal from foot presence sensor 72 when a user removes his or her feet from the opening 25 so that the power to the motor of the massage unit is interrupted to conserve power. During this time, the timer continues to run and if the timer has not expired and the user's foot is placed back in the opening 25 as detected by the foot presence sensor 72, the motor may be reactivated for the duration of the timer. In this way power is conserved, improving the life of the batteries. Each of the card reader 36 and the timer 34 and control unit 42 may be powered by the sealed batteries 45.

The control unit 42 may also provide for voltage monitoring of the sealed batteries 45 so as to provide a signal when charging is required. That signal may be an LED 66 visible on the outside of the massage unit 10 which may blink when charging is required to alert service personnel. Alternatively, the control unit 42 may incorporate a radio transceiver, for example, Bluetooth, Wi-Fi, or cellular, to provide for wireless communication through antenna 68 to remotely signal service personnel when charging is required. The signal provided may indicate the state of the battery (e.g., needs charge or percent remaining charge life) as well as an identification of the particular massage unit 10, for example, through the use of the serial number. Each massage unit 10 may have external markings 67 helping service personnel identify units needing charging as indicated by the signal provided through antenna 68 as augmented by the LED 66.

Charging may be accomplished by connecting a standard automotive battery charger 70 to the massage unit 10 through the charging socket 43. The automotive battery charger may be easily moved, among stationary massage units 10 and connect with line power with its own line cords during this time but then be completely removed to eliminate the tangle or interference of cords connecting the massage unit 10 to a wall socket. In an alternative embodiment, charging may be accomplished by a battery powered battery charger on a hand truck or the like or by removing the internal sealed batteries 45 and replacing different charged internal sealed batteries 45, eliminating the need for the standard automotive battery charger 70.

Certain terminology is used herein for purposes of reference only, and thus is not intended to be limiting. For example, terms such as “upper”, “lower”, “above”, and “below” refer to directions in the drawings to which reference is made. Terms such as “left”, “right”, “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence, or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

Various features of the invention are set forth in the following claims. It should be understood that the invention is not limited in its application to the details of construction and arrangements of the components set forth herein. The invention is capable of other embodiments and of being practiced or carried out in various ways. Variations and modifications of the foregoing are within the scope of the present invention. It also being understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

What is claimed is:

1. A leg vibration unit comprising:
a housing providing a base supportable on a floor and an opening in a front side of the housing;
an electric vibration unit fixed within the housing and having a footplate for receiving a user's feet, the footplate being angled and the opening positioned so that a user may place his or her feet on the footplate from an adjacent seat displaced horizontally from the housing when the base is positioned on the floor proximate to the seat;
at least one battery positioned within the housing and sized to provide power necessary to operate the electric vibration unit for no less than five minutes; and
a control unit controlling an application of power from the at least one battery to the electric vibration unit according to a predetermined time period.

2. The leg vibration unit of claim 1 wherein the housing further includes a charge indicator exposed on an outer suffice of the housing indicating a charge state of the batteries.

3. The leg vibration unit of claim 1 wherein the housing further includes a charging port exposed on an outer surface of the housing for receiving electrical power from an external charging device and communicating that power to charge the at least one battery.

4. The leg vibration unit of claim 1 wherein the housing further includes a foot presence sensor communicating with the control unit to remove power from the at least one battery to the electric massage unit when the foot presence sensor indicates that the user's feet are not present on the footplate of the electric vibration unit.

5. The leg vibration unit of claim 2 wherein the control unit provides power to the electric massage unit only if both the foot presence sensor indicates the presence of the user's feet on the footplate of the electric vibration unit and the predetermined time period has not expired.

6. The leg vibration unit of claim 1 wherein the housing further includes a device charging port exposed on an outer surface of the housing for providing electrical power from the at least one battery to an external device for charging the batteries of the external device.

7. The leg vibration unit of claim 6 wherein the device charging port conforms to a USB standard.

8. The leg vibration unit of claim 1 wherein the leg vibration unit employees a DC electric motor.

9. The leg vibration unit of claim 1 wherein the control unit further includes a radio transmitter for transmitting an indication of a state of the batteries together with an identification of the leg vibration unit.

10. The leg vibration unit of claim 1 wherein the housing further includes a payment receipt unit exposed on an outer surface of the housing for receiving payment for massage time and wherein the control unit controls the application of power from the batteries to the electric vibration unit according to whether payment is received.

11. The leg vibration unit of claim 10 wherein the control unit deactivates the payment receipt unit to prevent receipt of payment when the at least one battery has a charge below a predetermined amount still sufficient to operate the control unit and the payment receipt unit.

12. The leg vibration unit of claim 1 wherein the housing further includes a cover at least partially positioned above the footplate.

13. The leg vibration unit of claim 12 wherein the cover includes a padded upper surface.

14. The leg vibration unit of claim 13 wherein the cover has an elevation of 17 to 22 inches above the floor when the base is on the floor and the cover is positioned to allow support of the users feet when the base is positioned proximate to the seat of the user.

15. The leg vibration unit of claim 1 wherein the leg vibration unit provides at least two sealed lead acid batteries providing at least 20 amp hours connected to provide 24 volts to an electric motor of the electric massage unit.

16. A method of delivering leg vibration services in a public space having pre-existing seating comprising:
(1) distributing multiple leg vibration units throughout the public space adjacent to seats of the seating, each leg vibration unit including: (a) a housing providing a base supportable on a floor and an opening in a front side of the housing; (b) an electric vibration unit fixed within the housing and having a footplate for receiving a user's feet, the footplate being angled and the opening positioned so that a user may place his or her feet on the footplate from an adjacent seat displaced horizontally from the housing when the base is positioned on the floor proximate to the seat; (c) at least one battery positioned within the housing and sized to provide power necessary to operate the electric vibration unit for no less than five minutes; and (d) a control unit controlling an application of power from the at least one battery to the electric vibration unit according to a predetermined time period; and
(2) on an occasional basis, moving a portable charger among the distributed multiple leg vibration units to recharge the units.
